(19) United States
(12) Patent Application Publication
(10) Pub. No.: US 2008/0109505 A1
(43) Pub. Date: May 8, 2008

(54) Fir Decimation Filter and Arrangement Comprising the Same

(75) Inventor: Anton Prantl, Graz (AT)

Correspondence Address: FISH & RICHARDSON PC, P.O. BOX 1022, MINNEAPOLIS, MN, 55440-1022, US

(73) Assignee: AUSTRIAMICROSYSTEMS AG, Unterpremstätten (AT)

(21) Appl. No.: 11/722,546

(22) PCT Filed: Dec. 22, 2005
(86) PCT No.: PCT/EP05/13931

§ 371 Date: Jul. 20, 2007

(30) Foreign Application Priority Data
Dec. 23, 2004 (DE) 10 2004 062 291.4

(51) Int. Cl. G06F 7/48

(52) U.S. Cl. 708/313

(57) ABSTRACT

A finite impulse response (FIR) decimation filter includes an input to receive an oversampled signal, and an output to provide an output signal having a sampling rate that is reduced by a decimation factor relative to the oversampled signal. The decimation factor corresponds to a sum of one and an order N of the FIR decimation filter. A supply is used to provide filter coefficients for the FIR decimation filter. One multiplication and addition entity is used in generating the output signal. The multiplication and addition entity is configured to perform multiplication by bit shifting and/or addition.

The present invention relates to an FIR decimation filter, featuring an input for the supply of an oversampled signal and an output for the delivery of a signal having a sampling rate which is reduced by a decimation factor relative to the oversampled signal, and an arrangement including the FIR decimation filter.

FIR filters (FIR=finite impulse response) are characterized by an impulse response of finite length, FIR filters are also designated as non-recursive filters or transverse filters.

Decimation filters are used for reducing the sampling rate in the case of an oversampled digital signal. Oversampled signals are produced in the case of analog-digital converters, for example, which work according to the ΔΣ principle (ΔΣ=delta-sigma). In a decimation filter which is connected downstream of the ΔΣ modulator, the data rate of the bit stream is reduced in order to allow effective further processing of the digital signal. Typical values of the reduction in the sampling rate are e.g. 32 to 512.

In addition to FIR filters, so-called IIR filters (IIR=infinite impulse response), Sinc filters or Comb filters and combinations of the same are also known for realizing the functionality of the decimation in a digital filter.

An FIR decimation filter of the type in question and further decimation possibilities for use in the context of ΔΣ conversion are described, for example, in the document

“Delta-Sigma Data Converters” by F. R, Norsworthy, chapter 13, pages 408-445, IEEE Press, 1996. In order to achieve low energy consumption and/or a small chip surface, Sinc filters or Comb filters are best suited for realizing a digital decimation filter according to said document

In addition to the multiplication and addition components, normally abbreviated as MAC, which are usually present in the case of digital filters and perform the basic operations of e.g. an FIR filter, such filters normally also require a memory for storing filter coefficients and a further memory for the data. While the filter coefficients can normally be stored in a non-volatile memory such as a ROM (ROM=read-only memory) or EPROM (EPROM erasable programmable read-only memory), a non-volatile memory is normally required for storing the data for the incoming data stream. However, these non-volatile memories incur a relatively high expense in the context of integration, e.g. in terms of chip surface arid power consumption.

In the case of an FIR filter of the filter order N, it is usually necessary for all filter coefficients and the last N values of the incoming data stream of the oversampled signal to be available in memory in order that the required calculations can be performed.

The present invention addresses the problem of specifying an FIR decimation filter which can be integrated at low expense. In this case, the FIR decimation filter should be suitable for decimation of an oversampled data stream such as that provided by a ΔΣ modulator.

According to the invention, the problem is solved by an FIR decimation filter which, in relation to the generic FIR decimation filter, is further developed such that the sum of the filter order of the FIR decimation filter and the number 1 is equal to the decimation factor of the FIR decimation filter.

Developments and advantageous embodiments of the proposed principle are the subject matter of the dependent claims.

The decimation factor represents the ratio of the sampling rate of the oversampled signal at the input to the sampling rate of the signal at the output of the FIR decimation filter. Hence the decimation factor is a measure for the reduction of the sampling rate.

The filter order N of the FIR decimation filter is determined by the number of filter stages of the filter. A filter stage normally comprises a delay element, coefficient multipliers and adders for summands. Instead of distributed summers, however, it is possible to provide a global summer at both the input and output or a single global summer at the output.

According to the proposed principle, it is possible completely to dispense with the volatile memories which are normally required in the case of FIR decimation filters. The volatile memories are normally used for intermediate storage of the bit sequence of the incoming oversampled signal at the input. This relationship is explained in greater detail below. Consequently, it is possible to dispense with a quantity of N memory locations for the values of the oversampled signal, said quantity corresponding to the filter order N of the FIR decimation filter.

According to the proposed principle, therefore, no further memory elements are required in addition to the coefficient memories and accumulators in the multiplier-accumulator stage. As a result of this, the expense of realizing the decimation filter is significantly reduced, particularly in respect of chip surface requirement, design expense, current demand and costs.

The proposed relationship, specifically that the decimation factor is equal to the sum of the filter order N of the FIR decimation filter and the number 1, has the effect that, in the case of the proposed filter, the data rate of the oversampled signal at the input of the FIR decimation filter is (N+1) times the data rate of the signal at the output of the FIR decimation filter.

The decimation factor is preferably equal to the quantity of the required filter coefficients of the FIR decimation filter. Hence the quantity of the required filter coefficients also amounts to the sum of the filter order N of the FIR decimation filter and the number 1.

According to the proposed principle, the bit sequence of the incoming data stream of the oversampled signal at the input of the FIR decimation filter does not have to be intermediately stored. For the purpose of digital data processing, provision need only be made instead for a multiplier and accumulator and a coefficient block in order to load the respectively current FIR filter coefficients.

For the purpose of supplying the filter coefficients to the FIR decimation filter, provision is preferably made for means for supplying filter coefficients.

The means for supplying filter coefficients can be provided internally in the decimation filter or connected externally. In this case, the filter coefficients can be stored as fixed values or supplied as a variable data word.

The means for supplying the filter coefficients is connected to a multiplication and addition entity.

In the FIR decimation filter, provision is preferably made for only one single multiplication and addition entity, this being connected to the means for supplying the filter coefficients.

The multiplication and addition entity is additionally coupled to the input for supplying the oversampled signal. As mentioned above, no intermediate storage of the incoming data is required in the case of this coupling.

If the coding of the oversampled signal at the input of the FIR decimation filter is a so-called single-bit signal, the multiplication and addition entity is preferably designed as an accumulator. A single-bit signal is represented by a digital data stream having a word width of 1 bit. In this case, only the accumulation of the weighted input data need be performed. The weighting of the input data takes place using the respective filter coefficients. A multiplication in the true sense is not necessary. Likewise, an additional time delay in the filter is not necessary; this is instead predetermined by the sampling rate of the incoming bit sequence of the data stream.

If the oversampled signal which can be supplied at the input is not present as a single-bit signal but as a multi-bit signal, a multiplication and addition entity is required. In this case, the multiplication can be replaced in a simple manner by means of so-called shifting and an addition in the true sense. When shifting a data word in a register, the data word is shifted by a specified number of significant places to the right or to the left. In the case of binary-coded data, for example, a shift of one position to the right or to the left corresponds to a doubling or halving of the data word. Hence a multiplication can be performed in a simple manner.

If only one accumulator is provided in the single-bit case, this is preferably designed to comprise a data input, a coefficient input and an output. The data input is connected to the input for supplying an oversampled signal. The coefficient input is connected to the means for supplying the filter coefficients in order to supply the filter coefficients. The output is connected to the output of the FIR decimation filter. Furthermore, the accumulator comprises a return input which is connected to the output of the FIR decimation filter.

The accumulator is configured for incrementing a stored value by the product of a value of the incoming oversampled signal, which value is currently present at the data input, and a filter coefficient. This incrementing takes place on the basis of a start position and until such time as every filter coefficient has been utilized once. The first filter coefficient is then used again in accordance with the filter rule after the content of the accumulator has been reset.

The means for supplying the filter coefficients is preferably designed as non-volatile memory for storing the filter coefficients. The filter coefficients can be permanently programmed. However, the filter coefficients can also be programmable such that the filter characteristics can be changed during the operation or between individual operating phases. The non-volatile memory is preferably designed as ROM (ROM=read-only memory).

As explained above, as memory means, the FIR decimation filter includes only the non-volatile memory for storing the filter coefficients and the multiplication and addition entity. A memory having random access, also known as RAM (RAM=random access memory), for intermediate storage of the incoming digital data of the oversampled signal is not required, however.

The means for supplying the filter coefficients is preferably configured for providing the filter coefficients according to the rule of a so-called 3-term window. In this case, the filter coefficients are formed according to a mathematical rule which comprises three terms, wherein the three terms are represented with the aid of trigonometric functions as multiple-s of 2π, specifically in the case of the three-term window method depending on 0π, 2π and 4π, i.e. even multiples of the number pi from zero to four.

Of course, other methods can also be used as alternatives for calculating the coefficients of FIR filters, e.g. other window methods or the Remez exchange algorithm. Window methods that can be used are the Hamming window method, the Hanning window method, the Blackman window method or the Kaiser window method.

In comparison with rectangular windows, the described window functions have the advantage that the coefficients are reduced gradually towards the boundary, thereby resulting in a better approximation of the desired frequency response of the FIR decimation filter.

The filter coefficients are preferably calculated as per the rule

$$W ( K ) = 0.375 + 0.5 \cdot cos ( 2 π \frac{K}{N} ) + 0.125 \cdot cos ( 4 π \frac{K}{N} )$$

according to a 3-term window including so-called maximum rolloff. In this case, N represents the filter order of the FIR decimation filter. The control variable K assumes each integer value in the range from −N/2 to +N/2 inclusive. This results in the individual coefficients W(K) as per the above rule.

The decimation factor at present is preferably 32, 512 or an intermediate value of these values.

In an arrangement including the proposed FIR decimation filter, attached to its input is preferably the output of a ΔΣ modulator which serves as an analog-digital converter and provides the oversampled signal.

If a plurality of signals are to be processed, provision can be made for a single ΔΣ modulator which is configured for working in a multiplex operation. In a preferred embodiment, a single FIR decimation filter can again be attached to this as per the aforementioned principle. In this case, a multiplexer or demultiplexer is preferably connected at the input of the ΔΣ converter and at the output of the FIR decimation filter. Using such an arrangement, the proposed simplified FIR decimation filter has no disadvantages whatsoever in comparison with an FIR decimation filter having optimal performance characteristics. This is generally always the case if successive sample values are independent of each other.

A further advantageous use of the present FIR decimation filter is derived if a plurality of analog-digital converters are implemented in a system. In this case, the FIR decimation filters which are connected downstream in each case can share a shared memory for the filter coefficients as per the proposed principle. Hence, for examples 32 analog-digital converters which are designed as ΔΣ converters can be arranged on one chip with a decimation filter connected downstream in each case, wherein only one shared coefficient ROM is required as non-volatile memory. This results in a significant saving in chip surface.

The invention is explained in greater detail below using exemplary embodiments and with reference to drawings, in which:

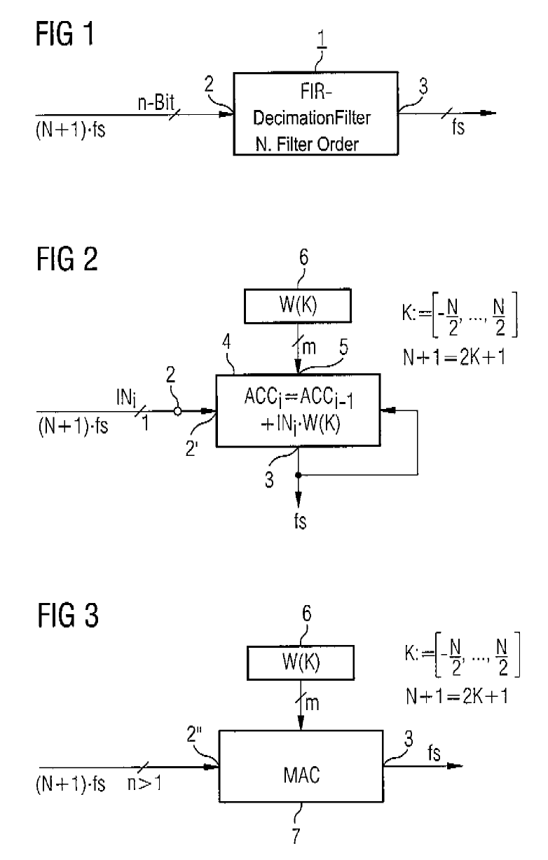

FIG. 1 shows a first exemplary embodiment of an FIR decimation filter according to the proposed principle,

FIG. 2 shows a further exemplary embodiment of an FIR decimation filter in a single-bit application,

FIG. 3 shows a further exemplary embodiment of an FIR decimation filter for a multi-bit application,

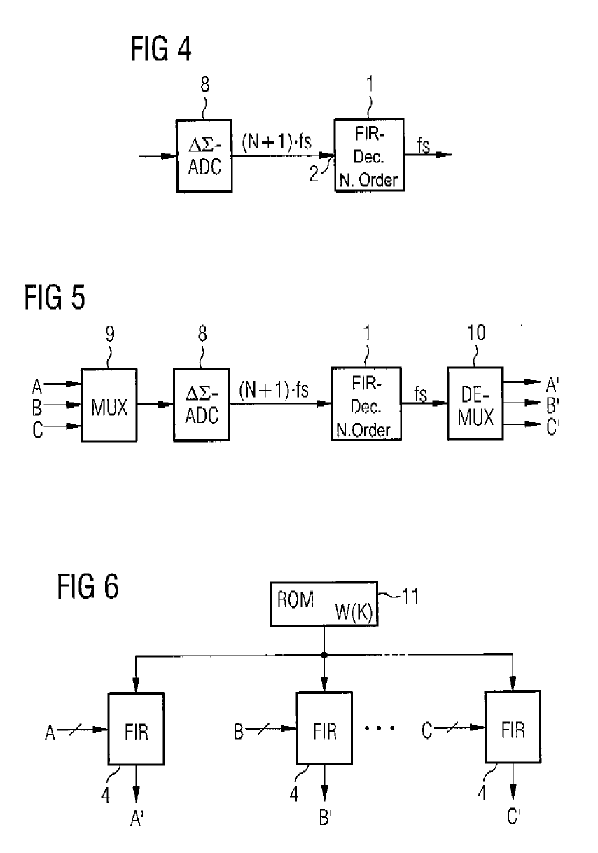

FIG. 4 shows an exemplary arrangement of the FIR decimation filter with a ΔΣ converter,

FIG. 5 shows an exemplary embodiment of the arrangement from FIG. 4 configured for multiplex operation, and

FIG. 6 shows an arrangement comprising a plurality of FIR decimation filters and a shared coefficient memory as an example.

FIG. 1 shows an FIR decimation filter 1 according to the proposed principle. The filter has the filter order N. An oversampled signal having a width of n bits can be supplied at an input 2. The bit width n can be 1 or more. The sampling rate of the oversampled signal is represented by a product of the filter order N increased by 1 and an output sampling rate fₛ. The output sampling rate at the output 3 of the filter is fₛ. Hence the decimation factor of the filter, this being calculated from the ratio of the sampling rate at the input to the sampling rate at the output, is exactly N+1 and therefore corresponds to the filter order N increased by 1.

FIG. 2 shows an exemplary embodiment of the decimation filter 1 for the case of a single-bit signal at the input 2. The ratios of the input sampling rate to the output sampling rate at the inputs and outputs 2, 3 of the FIR decimation filter has remained the same. The bit stream of the oversampled signal at the input 2 is designated as INᵢ, wherein INᵢ is a sequence of individual bits and the index variable i represents a control variable. An accumulator 4 which is incorporated in the FIR decimation filter is wired between an input 2′ and an output 3. The input 2′ of the accumulator 4 is connected to the input 2 of the FIR decimation filter. The output of the accumulator 4 forms the output 3 of the FIR decimation filter. In addition to the data input 2′, the accumulator 4 has a coefficient input 5 which is connected to the output of a coefficient memory 6. Furthermore, provision is made for a return input of the accumulator 4, said return input being connected to the output 3 for the purpose of providing the accumulation value. The coefficient memory 6 is designed as non-volatile memory and forms a means for supplying the filter coefficients. The coefficient memory is configured for storing a quantity of N+1 filter coefficients, wherein the quantity of the filter coefficients corresponds exactly to the decimation factor N+1 of the filter, i.e. to the filter order N incremented by 1. The coefficients have a width of m bits. The symbol k represents an index variable which assumes each integer value in the range from −N/2 to +N/2, wherein the range includes the boundary values. It applies that the filter order increased by 1 is equal to the quantity of the filter coefficients and hence is equal to the sum of 2k+1, i.e. twice the quantity of the integer values in the range from −N/2 to +N/2 plus 1. In the present example, the accumulator 4 works in accordance with an accumulation ruler according to which a new accumulation value is calculated from the sum of the accumulation value in the previous step and the product of the current bit INᵢ of the data stream of the oversampled signal, said current bit being present at the input, and the relevant filter coefficient W(k). The accumulation value is provided at the output in a bit sequence having a reduced sampling rate.

It is clear that a memory for the last N bits of the incoming data INᵢ is not required at the input 2 in order to be able to execute the necessary computing operations of the FIR decimation filter.

In the present single-bit case, it is likewise not necessary to have a multiplier in the true sense. This is because the input bit INᵢ normally assumes only two values, specifically +1 or −1, such that the current filter coefficient is either added to or subtracted from the accumulation value of the previous step. Consequently, no multiplication is performed.

The filter coefficient memory 6 is configured for providing the filter coefficients in accordance with the rule of a so-called 3-term window. In this case, the filter coefficients are formed according to a mathematical rule which comprises three terms, said three terms being represented with the aid of trigonometric functions as multiples of 2π, specifically in the case of the three-term window method depending on Or, 2π and 4π, i.e. even multiples of the number pi from zero to four.

In comparison with rectangular windows, the described window functions have the advantage that the coefficients are reduced gradually towards the boundary, thereby resulting in a better approximation of the desired frequency response of the FIR decimation filter.

In the present exemplary embodiment, the filter coefficients arc calculated as per the rule

$$W ( K ) = 0.375 + 0.5 \cdot cos ( 2 π \frac{K}{N} ) + 0.125 \cdot cos ( 4 π \frac{K}{N} )$$

according to a 3-term window including so-called maximum rolloff. In this case, N represents the filter order of the FIR decimation filter. The control variable K assumes each integer value in the range from −N/2 to +N/2 inclusive. This results in the individual coefficients W(K) as per the above rule.

The decimation factor at present is preferably 32, 512 or an intermediate value of these values.

As mentioned above, apart from the accumulator itself, no further volatile memory is required. Overall, with the exception of the accumulator 4 and the filter coefficient memory 6, no further memory means are required in order to realize the FIR decimation filter as per FIG. 2.

FIG. 3 shows a modification of the circuit from FIG. 2 in the case of a multi-bit-coded oversampled signal at the input 2. The bit width of the data word at the input is therefore greater than 1. In comparison with FIG. 2, instead of the accumulator 4, in this case provision is made for a multiplication and accumulation block 7 which is again connected to the coefficient memory 6 via a line having a width of k bits. The input 2 is connected to an input 2″ of the multiplication and accumulation block 7. The signal having a reduced sampling rate is again provided at the output 3.

With reference to FIG. 2, therefore, the accumulator 4 is replaced by the multiplication and accumulation block 7. It nonetheless still applies that no volatile memory is required for intermediate storage of the input data stream. An actual multiplication in the multiplication and accumulation block 7 is likewise not required. Instead, this can be replaced by combinations of the two steps shifting a data word and additions. For example, therefore, a multiplication or division by the factor 2 in the case of a binary-coded signal can be effected by shifting the data word by one place to the right or to the left. Multiplications and additions by powers in base 2 are effected by means of a shift by a quantity of hits which corresponds to the power in base 2. A multiplication by the factor 3 is simply achieved by first shifting the data word by one significant place then adding the data word itself again to the intermediate result. A multiplication or division by the factor 4 is simply achieved by shifting the data word by two significant places. Consequently, for example, multiplications by factors of −4 to +4 can be carried out without actual multiplication, and instead replaced by simple shifting and adding. The computing effort is therefore particularly low. In the example from FIG. 3, as in the example as per FIG. 2, it applies that the last N data words of the oversampled signal at the input 2 do not need to be intermediately stored.

FIG. 4 shows an exemplary embodiment of an arrangement of the FIR decimation filter from FIG. 1 and a ΔΣ modulator 8 (ΔΣ=sigma-delta) which is designed as an analog-digital converter. The ΔΣ modulator $ works with an oversampling. In this case, the output of the ΔΣ modulator 8 at its output is connected to the input 2 of the FIR decimation filter 2 for the purpose of providing the oversampled signal at the input 2.

The FIR decimation filter 1 according to the proposed principle reduces the sampling rate of the oversampled signal of the ΔΣ modulator 8 to a sampling rate value which is suitable for further digital processing, as explained with reference to FIGS. 1 to 3, for example.

FIG. 5 shows the arrangement from FIG. 4, configured for multiplex operation by way of example. For this, a multiplexer 9 which has a plurality of inputs for supplying different and independent signals A, B, C is connected to the input of the ΔΣ modulator 8. These signals are supplied to the ΔΣ modulator 8 alternately. Connected to the output of the FIR decimation filter 1, which processes the signals A, B, C alternately in the same way as the ΔΣ modulator 6, is a demultiplexer 10 that splits the digitized and decimated signal sequence A, B, C into the respective signals A′, B′, C′ again. Using such an arrangement, having a particularly simple construction and without volatile memory, the proposed FIR decimation filter 1 achieves properties which are equally as good as those of an optimal FIR decimation filter.

A further advantageous application area of the proposed FIR decimation filter 1 is shown in FIG. 6 by way of example. A plurality of FIR decimation filters are shown therein. The FIR decimation filters have the exemplary structure as per FIG. 2, including an accumulator 4 each, but having a shared coefficient memory 11 instead of a dedicated coefficient memory 6 each. The shared coefficient memory 11 is connected to a coefficient input of the accumulators 4 in each case. One input is provided in each case for supplying an oversampled signal at respective data inputs of the accumulators 4. As a result of the shared memory for filter coefficients 11 for all accumulators 4, the chip surface of such an arrangement can be significantly reduced.

### List of Reference Numerals

1 FIR decimation filter
2 Input
2′ Input
2″ Input
3 Output
4 Accumulator
5 Coefficient input
6 Memory for filter coefficients
7 Multiplication and accumulation block
8 ΔΣ modulator
9 Multiplexer
10 Demultiplexer
11 Coefficient memory

1-15. (canceled)

16. A finite impulse response (FIR) decimation filter, comprising:
an input to receive an oversampled signal;
an output to provide and output signal having a sampling rate that is reduced by a decimation factor relative to the oversampled signal, wherein the decimation factor corresponds to a sum of one and an order N of the FIR decimation filter;
a supply to provide filter coefficients for the FIR decimation filter; and
one multiplication and addition entity for use in generating the output signal, the multiplication and addition entity being configured to perform multiplication by bit shifting and/or addition.

17. The FIR decimation filter of claim 16, wherein the decimation factor corresponds to a quantity of filter coefficients required for the FIR decimation filter.

18. The FIR decimation filter of claim 16, wherein the multiplication and addition entity comprises and accumulator.

19. The FIR decimation filter of claim 18, wherein the accumulator comprises:
a data input that is in series with the input of the FIR decimation filter;
a coefficient input to receive the filter coefficients;
a data output that forms the output of the FIR decimation filter; and
a feedback that is connected to the output of the FIR decimation filter, the feedback for providing the output signal back to the accumulator.

20. The FIR decimation filter of claim 19, wherein the accumulator is configured to increment a stored value by a product of a value at the data input and a filter coefficient.

21. The FIR decimation filter of claim 16, wherein the supply comprises a non-volatile memory to store the filter coefficients.

22. The FIR decimation filter of claim 16, wherein the supply comprises a non-volatile memory to store the filter coefficients and the multiplication and addition entity.

23. The FIR decimation filter of claim 16, wherein the supply is configured to provide the filter coefficients according to a three-term-window rule.

24. The FIR decimation filter of claim 16, wherein the supply is configured to determine filter coefficients W(K), as follows:
$$W ( K ) = 0.375 + 0.5 \cdot cos ( 2 π \frac{K}{N} ) + 0.125 \cdot cos ( 4 π \frac{K}{N} ) ,$$
where K assumes each integer value in a range from −N/2 to +N/2 inclusive.

25. The FIR decimation filter of claim 16, wherein the decimation factor has a value within a range of 32 to 512 inclusive.

26. A system comprising:
the FIR decimation filter of claim 16; and
a sigma-delta modulator in series with the input of the FIR decimation filter, the sigma-delta modulator being configured to provide the oversampled signal.

27. The system of claim 26, wherein the sigma-delta modulator is configured to process a plurality of multiplexed signals.

28. The system of claim 26, wherein the sigma-delta modulator comprises an analog-to-digital converter.

29. A system comprising:
plural finite impulse response (FIR) decimation filters; and
a common supply to provide filter coefficients for the plural FIR decimation filters;
wherein each of the plural FIR decimation filters comprises:
an input to receive an oversampled signal;
an output to provide an output signal having a sampling rate that is reduced by a decimation factor relative to the oversampled signal, wherein the decimation factor corresponds to a sum of one and an order N of an FIR decimation filter; and
one multiplication and addition entity for use in generating the output signal, the multiplication and addition entity being configured to perform multiplication by bit shifting and/or addition.

30. The FIR decimation filter of claim 29, wherein the multiplication and addition entity comprises an accumulator.

31. The FIR decimation filter of claim 30, wherein the accumulator comprises:
a data input that is in series with the input of the FIR decimation filter;
a coefficient input to receive the filter coefficients;
a data output that forms the output of the FIR decimation filter; and
a feedback that is connected to the output of the FIR decimation filter, the feedback

32. The FIR decimation filter of claim 29, wherein the accumulator is configured to increment a stored value by a product of a value at the data input and a filter coefficient.

33. The FIR decimation filter of claim 29, wherein the supply is configured to determine filter coefficients W(K), as follows:
$$W ( K ) = 0.375 + 0.5 \cdot cos ( 2 π \frac{K}{N} ) + 0.125 \cdot cos ( 4 π \frac{K}{N} ) ,$$
where K assumes each integer value in a range from −N/2 to +N/2 inclusive.

34. The FIR decimation filter of claim 29, wherein the decimation factor has a value within a range of 32 to 512 inclusive.
